(19) United States
(12) Patent Application Publication
(10) Pub. No.: US 2014/0165377 A1
(43) Pub. Date: Jun. 19, 2014

(54) BEARING PLATE WITH PRESSURE ELEMENTS

(71) Applicant: KRONES AG, Neutraubling (DE)

(72) Inventor: Josef Kaiser, Regensburg (DE)

(73) Assignee: KRONES AG, Neutraubling (DE)

(21) Appl. No.: 14/088,671

(22) Filed: Nov. 25, 2013

(30) Foreign Application Priority Data
Dec. 19, 2012 (DE) 102012223771.2

(51) Int. Cl. B25B 11/00

(52) U.S. Cl. CPC B25B 11/00
USPC 29/559; 269/57

(57) ABSTRACT

A bearing plate for positioning containers with a main body, having at least one first pressure element being arranged on the main body, where the first pressure element is arranged at least in part parallel to the main body, and furthermore a positioning being arranged on the main body and including at least one opening through which the first pressure element protrudes at least in part, and where the positioning body is formed as a second pressure element.

### CROSS-REFERENCE TO RELATED APPLICATION

The present application claims the benefit of priority of German Application No. 102012223771.2, filed Dec. 19, 2012. The entire text of the priority application is incorporated herein by reference in its entirety.

### FIELD OF THE DISCLOSURE

The present disclosure relates to a bearing plate for positioning containers.

### BACKGROUND

It is already known from prior art to provide bearing plates for positioning containers. It is further known to provide this bearing plate with spring elements.

For example, WO 2008/067 907 A1 discloses a bearing plate for positioning containers having at least one pressure element, where a positioning body is arranged on the main body, through the opening of which the pressure element can protrude and which can be used for positioning the container.

### SUMMARY OF THE DISCLOSURE

One aspect of the disclosure is to improve existing bearing plates in terms of their ability to receive and ability to position containers of varying dimensions.

According to the disclosure, the bearing plate for positioning a container has the positioning body formed as a second pressure element. By using two pressure elements, it can be ensured that a container to be positioned can be properly positioned even with varying diameters. It is particularly advantageous that a container to be positioned, due to the design of the positioning body as a second pressure element, can always be positioned at the same height, even if its diameter is larger than the opening in the positioning device.

In one embodiment, the bearing plate has the first pressure element is designed in the shape of a cross. This achieves stable positioning of the container.

In a further embodiment, the positioning body comprises a bevel in a region adjacent to the first pressure element, where the bevel includes at least an angle of 30°, preferably an angle between 30° and 60°, particularly preferably an angle of 45° with the horizontal. This bevel firstly allows for lowering the positioning body in dependency of the diameter of the container and secondly for the securest possible stabilization of a container positioned on the bearing plate.

In a further embodiment, the first pressure element is made of polyurethane and/or rubber or comprises an outer coating consisting thereof, and/or the positioning body is made of polyurethane or comprises an outer coating made thereof. Providing the bearing plate or the first pressure element and the positioning body with polyurethane or rubber increases the friction between these elements and the containers positioned thereon, whereby more secure footing can be ensured.

In one embodiment, the bearing plate includes that at least four spring elements are provided connecting the first pressure element with the main body and/or in that at least four spring elements are provided connecting the positioning body with the main body. The respective spring elements can in a structurally simple manner enable a reaction of the first pressure element and the positioning body, for example, to forces exerted by the weight of the container.

In a corresponding embodiment, the spring elements connecting the first pressure element with the main body and/or the spring elements connecting the positioning body with the main body are evenly distributed around the unit circle. A respective distribution of the spring elements also allows uniform distribution of forces, whereby further acting forces can be distributed evenly.

In one embodiment, the bearing plate includes that the first pressure element and/or the positioning body are embodied as an elastic element. With this embodiment of the pressure element and the positioning body, for example, further spring elements, which would act e.g. to the weight force of a container positioned on the bearing plate, can be omitted, whereby the design of the bearing plate is less complex and therefore less susceptible to failure.

By using, for example, this device, a positioning method for containers includes a bearing plate comprising at least one main body, where the main body comprises a first pressure element on which a container is positioned and which is arranged at least in part parallel to the main body, and furthermore comprises a positioning body being arranged on the main body and comprising at least one opening through which the first pressure element protrudes at least in part and is formed as a second pressure element, wherein the positioning method includes that a container positioned on the first pressure element and/or the positioning body changes the position relative to the main body of the first pressure element and/or of the positioning body in dependency of forces transmitted onto the first pressure element and/or the positioning body. For example, containers can thereby be positioned even when they have varying dimensions, such as diameters. Dimensional variations resulting from the production of the containers can thereby be compensated.

In one embodiment, the positioning method includes that distribution of the forces acting upon the at least four spring elements is provided, connecting the first pressure element with the main body and/or, in that the at least four spring elements, connecting the positioning body with the main body, is effected by these elements. In this manner, one-sided loads on the first pressure element and/or on the positioning body can be avoided.

In one embodiment, uniform distribution of forces is ensured by the uniform distribution of the spring elements on the unit circle. Uniform distribution of forces can be achieve even with non-symmetrical loads on the first pressure element or positioning body, whereby more stable positioning of the container is possible.

In another embodiment, the positioning method includes that the container is centered by a bevel on the positioning body provided on the side facing the first pressure element. This bevel firstly effects centering of the container to be positioned, and secondly, it allows a corresponding reaction of the positioning body with varying dimensions of the container to be positioned.

### BRIEF DESCRIPTION OF THE FIGURES

FIG. 1 shows a bearing plate according to prior art.

FIGS. 2a and b show a bearing plate according to the disclosure in a preferred embodiment.

FIGS. 3a and b show a bearing plate according to the disclosure with containers of varying sizes.

FIGS. 4a and b show a further embodiment of the bearing plate with elastic elements.

### DETAILED DESCRIPTION OF THE PREFERRED EMBODIMENT

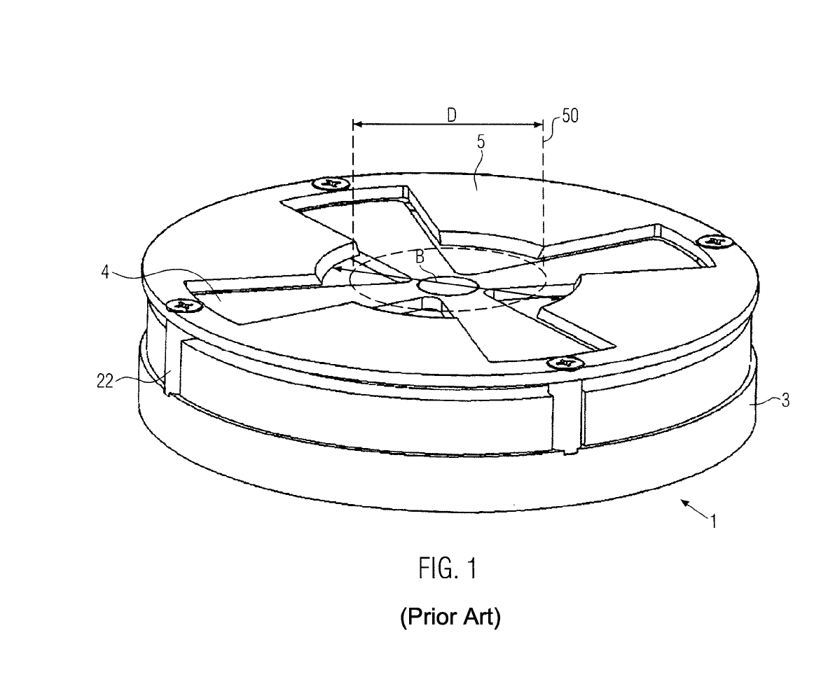

FIG. 1 shows a bearing plate as it is known from prior art used, for example, in labelers. The bearing plate 1 comprises a main body 3 to which a positioning body 5 is attached using fixed connections, for example, screwed connections 22. The positioning body 5 comprises an opening into which a pressure element 4 is inserted. The pressure element in a non-loaded state coincides with the surface of the positioning body facing upwardly, or can be slightly lowered. The pressure element is spring-mounted and can move up and down relative to the main body 3 in dependency on the forces acting upon the pressure element 4. For example, a container mounted on this bearing plate, to the extent that it rests at least in part or entirely on the pressure element 4, exerts a force on this pressure element 4, whereby the latter is lowered. How far the pressure element 4 is lowered relative to the initial position is in relation to the strength of the springs (spring constant) and the forces applied. This is, firstly, the weight of the container 50 itself, if the bearing plate 1 is not arranged vertically (that means, the normal of the pressure element 4 is perpendicular to the vector of the gravitational force) and, secondly, further acting forces, which can, for example, be transmitted via the container. This denotes in particular forces transmitted via mounts holding the container 50 and exerting a load on its closure.

However, it turns out to be disadvantageous that, though the positioning device 5 may possibly comprise a guide in the form of bevels on the inner side (the edge facing the pressure element) to allow the container 50 to slide in even with an initial misalignment, changes in the dimensions of the container 50, in particular with production-related variation in the diameter, however, can impair the bearing plate from functioning in this manner, since, if the diameter D of the container is greater than the diameter B of the opening in the positioning device, the container 50 remains in the position in which the diameter D is equal to or greater than the diameter B of the opening. In extreme cases, the container 50 does not sink in at all, which could result in having it positioned at an incorrect height and, for example, at which application of a label is hardly possible or the result of a labeling process is impaired. On the other hand, however, a rigid positioning device 5 and a pressure element 4 independently movable away thereform are necessary in order to ensure the desired lowering and the positioning related thereto of the container 50 for the labeling operation. When using a different container, it is therefore necessary to replace at least the positioning device 5 or the entire bearing plate. But this is not desired, especially during an ongoing production process, in which the dimensions of the various containers differ only in terms of production accuracy, because this causes long downtimes. One solution would be to enlarge the opening of the positioning device 5 so that all containers 50 having a diameter D in a certain value range fit through this opening. Very small containers 50 (with a diameter then less than B), however, would, compared to containers 50 having a diameter D equal to the diameter D of the opening, have the disadvantage that secure positioning could then no longer be ensured.

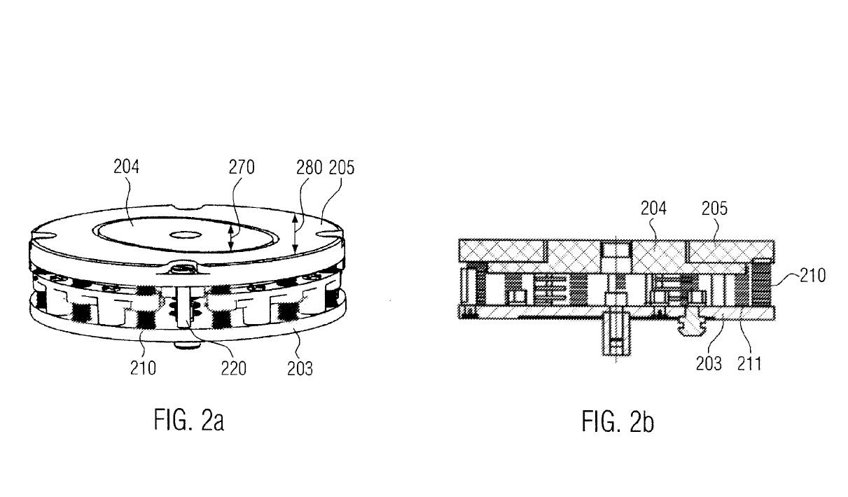

This problem, however, can be solved with the aid of a bearing plate according to the disclosure according to FIG. 2a. This bearing plate differs from the one known from prior art and illustrated in FIG. 1, in that the rigid connections, for example screw connections 22 of FIG. 1 for connecting the positioning device with the main body, were omitted and replaced by elements 210. These elements can be, for example, springs. The positioning device 205 is thereby no longer rigidly mounted but instead can react to forces that are exerted upon this positioning device 205 by compression of the spring elements 210. Despite this variation of prior art, guide screws 220 can still be provided, which are connected with the main body 203 and the positioning device 205, but in such a manner that the positioning device 205 can be lowered according to the acting forces in a manner bring guided along the arrow 280 by the guide connections 220.

FIG. 2b shows a side view of the bearing plate 2a of FIG. 2a. Here as well, the spring elements 210 for suspension of the positioning device 205 are illustrated and additional spring elements 211 for the suspension of the pressure element 204. The main body 203 is preferably rigidly connected with the respective machine or another part such that forces acting upon the positioning device 205 or the pressure element 204, respectively, can allow for compression of the spring elements 210 and 211 and thereby lowering of the positioning device 205 and/or the pressure element 204.

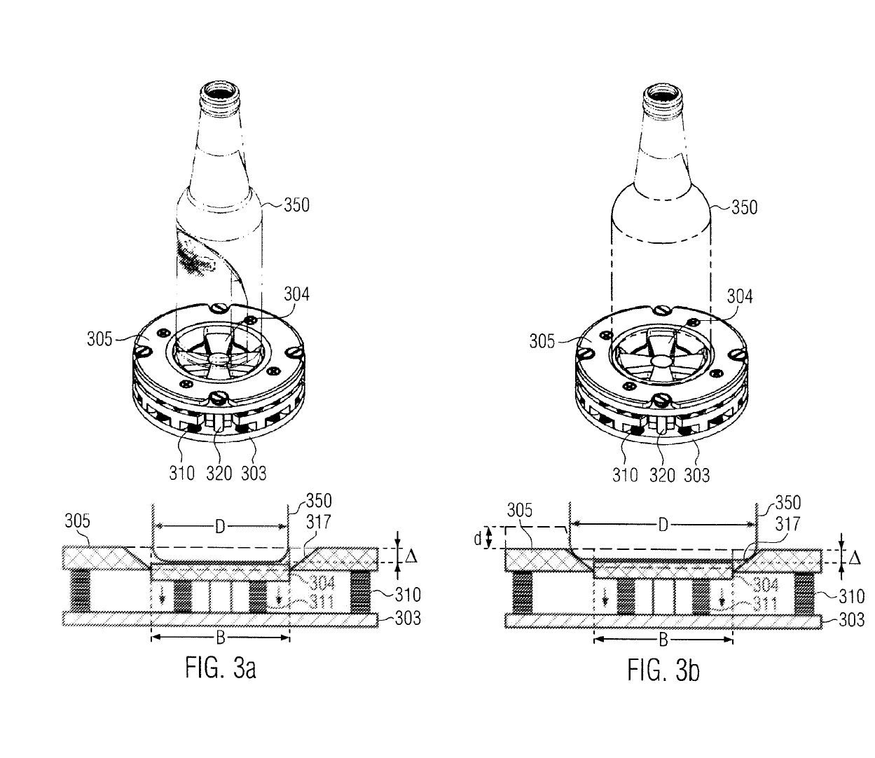

FIG. 3 shows the mode of operation of the bearing plate according to the disclosure. FIG. 3a shows the mode of operation of the bearing plate for positioning a container with a diameter D smaller than the diameter B of the opening 305 of the positioning device 305. In this case, the bearing plate functions similarly to the bearing plate already known from prior art. A container 350 possibly entering in a slanted manner can first be aligned by the bevels 317 on the side of the positioning device facing the pressure element 304. This ensures that it is located at least on or directly above the pressure element 304. It is then lowered vis-à-vis the original position by the value A due to the acting forces independently of the positioning device 305. For this, the bevel 317 has an angle of 30°, preferably an angle between 30° and 60°, particularly preferably an angle of 45°, that is formed with the horizontal.

FIG. 3b illustrates the mode of operation of the bearing plate from FIG. 2 when a container 350 with a diameter D greater than the diameter B of the opening 305 of the positioning device is positioned on the bearing plate. Also in this case, the bevels 317 of the positioning device 305 first provide for an alignment of the container 350. However, contrary to the prior art bearing plate, in this case, the force acting upon the container 305 leads to the positioning device 305 being lowered by a distance d, so that contact with the pressure element 305 is further established, which is then again displaced by a distance A due to the forces acting. Depending on whether the surface of the positioning device 305 facing away from the main body 303 is at a farther distance than the surface of the pressure element 304 facing away from the main body 303, either the pressure element 304 or the positioning device 305 is moved a further distance from the initial position. In the event that the distance of the surface of the positioning device 305 facing away from the main body 303 is in the initial position greater than the distance of the surface of the pressure element 304 facing away from the main body 303, d will be greater than A. In the opposite case, d is less than A.

In this manner, it is ensured that the container is in each case lowered by the distance A relative to the initial position due to the forces acting upon it. It is additionally ensured that a maximum bearing surface of the underside of the container 350 rests on the pressure element 304 at all times. It is likewise ensured, that centering can be achieved due to the bevel 317 regardless of the diameter, as long as it is not significantly smaller than the diameter B of the opening 305 of the positioning device 317 or larger than the outer perimeter of the bevel 317, respectively.

In order to achieve ideal distribution of the forces, it is preferred that the spring elements 310 or 311, respectively, are distributed at the same distance from an imaginary center axis S and uniformly on the unit circle. The points at which the force is transmitted to the spring elements or to the main body 303, respectively, are distributed in a rotationally symmetrical manner, which enables more stable alignment and positioning of the container. Depending on the weight distribution and the distribution of forces, however, also asymmetrical positioning of the spring elements can be preferred, adapted to the directions of the forces acting. For increasing adhesion of the container on the positioning device 305 or the pressure element 304, respectively, they can be made either of polyurethane or rubber or comprise a respective coating, in particular on the side facing the container bottom. Other materials increasing adhesion properties used as container material are also conceivable.

Furthermore, an embodiment of the positioning device and the pressure element using elastic materials is possible.

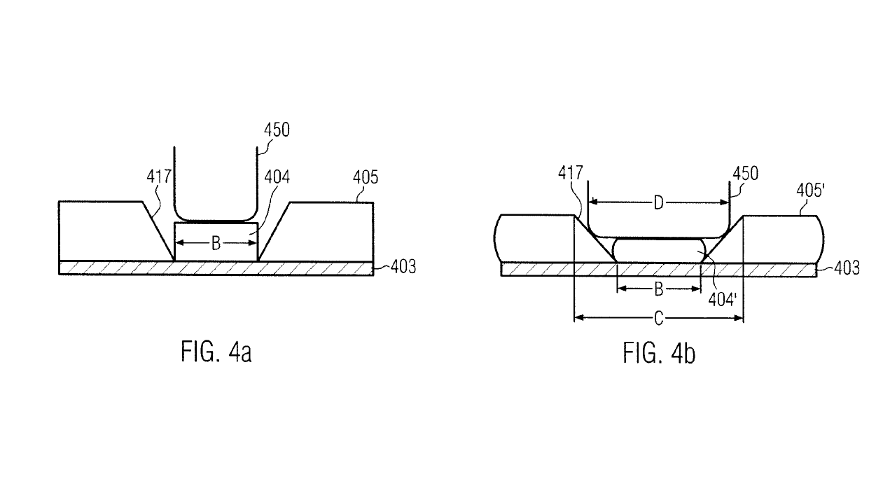

FIG. 4 shows such an embodiment in which the positioning device 405 and the pressure element 404 are directly connected with the main body 403 and are designed as elastic elements. FIG. 4a shows the initial situation in which no container and therefore no further forces are acting upon the positioning device 405 and the pressure element 404. In this case, these components have their original shape. Although this original shape is presently shown as being angular, this is no restriction to possible embodiments of the positioning device 405 and the pressure element 404. Other embodiments, for example, rounded shapes are here conceivable. It is essential, however, to provide the bevel 417 on the edge of the opening of the positioning device 405 facing the pressure element.

FIG. 4b illustrates the mode of operation of the bearing plate according to this embodiment when a container 405 with a diameter D greater than the diameter B of the opening of the positioning device 405 and smaller than the diameter of the opening of the upper end of the bevel 417 of the positioning device 405 is used. Due to the forces acting, which are transmitted via the container, there is a deformation of the elastic positioning device 405 such that it assumes the shape 405′ and an elastic deformation of the pressure element 404 such that it assumes the shape 404′. Deformation according to the shape presently shown, i.e. escape of the material towards the sides, is not necessary. If, for example, appropriate elastic foams are used, then lowering without significant expansion in a different direction can here also occur. The modes of operation of this elastic positioning device 405 and the pressure element 404 correspond to those of the embodiment as described in FIG. 3. Therefore, they shall presently not be repeated in detail.

It is particularly advantageous that the two embodiments are combinable, i.e., while one is embodied as the positioning device or the pressure element using spring elements, the other may be embodied as an elastic element.

It should also be mentioned here that configuration of the opening of the positioning device as shown in the preceding embodiment is not mandatory. The opening can advantageously correspond to the shape of the surface of the container positioned on the bearing plate and here, for example, have an angular shape, in particular triangular or quadrangular, or an oval shape. Embodiment of the first pressure element can also be varied. A configuration with the shape of a cross can be advantageous for weight distribution to the spring elements. But also continuous shapes which are adapted to the size of the opening are possible. In particular when using elastic materials as the first pressure element and/or as the positioning device, the use of the simplest possible geometrical structures, such as circles, circular rings, rectangles, triangles, etc. is advantageous due to the ease of manufacture and reliable operation.

What is claimed is:

1. A bearing plate for positioning containers with a main body, comprising at least one first pressure element being arranged on the main body where the first pressure element is arranged at least in part parallel to the main body, and a positioning body being arranged on the main body and at least one opening through which the first pressure element protrudes at least in part, and the positioning body being formed as a second pressure element.

2. The bearing plate according to claim 1, said wherein the first pressure element is designed in the shape of a cross.

3. The bearing plate according to claim wherein the positioning body comprises a bevel in a region adjacent to the first pressure element, wherein the bevel includes at least an angle between 30° and 60 with the horizontal.

4. The bearing plate according to claim 1, wherein the first pressure element is made of one of polyurethane, rubber, and a combination thereof, or has an outer coating made thereof, and
the positioning body is made of polyurethane or comprises an outer coating made thereof.

5. The bearing plate according to claim 1, and wherein one of at least four spring elements are provided connecting the first pressure element with the main body, at least four spring elements are provided connecting the positioning body with the main body, and a combination thereof.

6. The bearing plate according to claim 5, wherein at least one of the spring elements connecting the first pressure element with the main body the spring elements connecting the positioning body with the main body are evenly distributed around a unit circle.

7. The bearing plate according to claim 1, wherein the first pressure element and/or the positioning body are embodied as an elastic element.

8. A method for positioning containers using a bearing plate comprising at least a main body, wherein the main body comprises a first pressure element onto which a container is positioned and which is arranged at least in part parallel to the main body, a positioning body being arranged on the main body and comprising at least one opening through which the first pressure element protrudes at least in part and is formed as a second pressure element, comprising changing the position of a container positioned on at least one of the first pressure element or the positioning body relative to at least one of the main body of the first pressure element or the positioning body in dependency of forces transmitted onto at least one of the first pressure element or the positioning body.

9. The method according to claim 8, and effecting the distribution of the forces acting upon at least one of the first pressure element or the positioning body by at least one of a group including at least four spring elements connecting the first pressure element with the main body, and the at least four spring elements connecting the positioning body with the main body.

10. The method according to claim 9, and effecting the uniform distribution of forces by the uniform distribution of the spring elements on a unit circle.

11. The method according to claim 8, and centering the container by a bevel of the positioning body provided on the side facing the first pressure element.

12. The bearing plate according to claim 3, wherein the angle of the bevel is with the horizontal 30°.

13. The bearing plate according to claim 3, wherein the angle of the bevel is with the horizontal 45°.
